(19) United States
(12) Patent Application Publication
(10) Pub. No.: US 2013/0097643 A1
(43) Pub. Date: Apr. 18, 2013

(54) INTERACTIVE VIDEO

(71) Applicants: Brian Stone, London (GB); Jerry Johnson, London (GB); Matthew White, Cambridgeshire (GB); Joshua Whitney Samuels Atkins, London (GB)

(72) Inventors: Brian Stone, London (GB); Jerry Johnson, London (GB); Matthew White, Cambridgeshire (GB); Joshua Whitney Samuels Atkins, London (GB)

(73) Assignee: Microsoft Corporation, Redmond, WA (US)

(21) Appl. No.: 13/275,124

(22) Filed: Oct. 17, 2011

(51) Int. Cl. H04N 21/472

(52) U.S. Cl. 725/61

(57) ABSTRACT

Embodiments are disclosed that relate to providing an interactive video viewing experience. For example, one disclosed embodiment includes receiving an interactive video program that comprises a first video segment and one or more branch video segments that each corresponds to a branch along a decision path. The method includes pre-buffering a transition portion of a corresponding branch video segment for each possible user input of one or more possible user inputs along the decision path. The method includes sending the first video segment to a display device and, based upon an actual user input, branching from the first video segment to a transition portion of a branch video segment that corresponds to the actual user input.

### BACKGROUND

Pre-recorded film and linear video, such as broadcast television programs, typically provide a passive viewing experience that does not allow for user interaction. Video games provide players with an interactive experience, typically utilizing computer graphics to create gaming scenes and scenarios. Some video games have used pre-recorded video sequences that are displayed in response to a user input. These games, however, typically pause at user input points to wait for a user input. Such delays interrupt the flow of the viewing experience and hinder a player's perception of participating in a real-time interaction. Additionally, when user input is provided, there is often a perceptible delay before the game advances to a follow-on sequence.

### SUMMARY

Embodiments are disclosed that relate to providing an interactive video viewing experience. For example, one disclosed embodiment comprises receiving an interactive video program that comprises a first video segment and one or more branch video segments that each corresponds to a branch along a decision path of the interactive video program. The method includes pre-buffering a transition portion of a corresponding branch video segment for each possible user input of a set of one or more possible user inputs along the decision path. The method further includes sending the first video segment to a display device and, based upon an actual user input that corresponds to a possible input from the set of one or more possible user inputs, branching from the first video segment to a transition portion of a branch video segment that corresponds to the actual user input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a media delivery and presentation environment.

FIG. 2 shows a flow chart of an embodiment of a method of providing an interactive video viewing experience.

FIGS. 3A and 3B show an embodiment of a decision path that is representative of a method of providing an interactive video viewing experience.

FIG. 4 shows a flow chart of another embodiment of a method of providing an interactive video viewing experience.

FIG. 5 shows a schematic illustration of an embodiment of a computing system.

FIG. 6 shows a simplified schematic illustration of an embodiment of a computing device.

### DETAILED DESCRIPTION

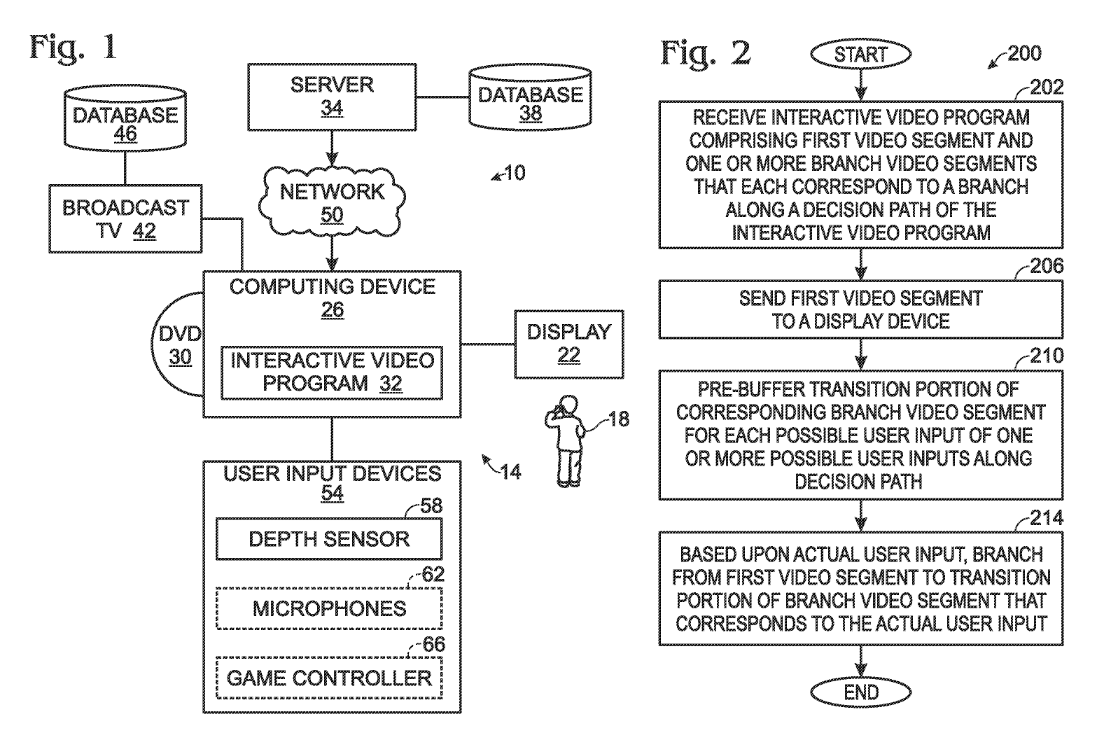

Embodiments are disclosed that relate to providing an interactive video viewing experience. With reference to FIG. 1, an example embodiment of a media delivery and presentation environment 10 may include a computing system 14 that enables a user 18 to view and/or interact with various forms of media via display device 22. Such media may include, but is not limited to, broadcast television programs, linear video, video games, and other forms of media presentations. It will also be appreciated that the computing system 14 may be used to view and/or interact with one or more different media types or delivery mechanisms, such as video, audio, tactile feedback, etc., and/or control or manipulate various applications and/or operating systems.

The computing system 14 includes a computing device 26, such as a video game console, and a display device 22 that receives media content from the computing device 26. Other examples of suitable computing devices 26 include, but are not limited to, set-top boxes (e.g. cable television boxes, satellite television boxes), digital video recorders (DVRs), desktop computers, laptop computers, tablet computers, home entertainment computers, network computing devices, and any other device that may provide content to a display device 22 for display.

In one example, and as described in more detail below, one or more interactive video programs, such as interactive video program 32, metadata, other media content, and/or other data may be received by the computing device 26 from one or more remote content sources. In FIG. 1, example remote content sources are illustrated as a server 34 in communication with a content database 38, and broadcast television provider 42 in communication with a content database 46. It will be appreciated that computing device 26 may receive content from any suitable remote content sources including, but not limited to, on-demand video providers, cable television providers, direct-to-home satellite television providers, web sites configured to stream media content, etc.

Computing device 26 may receive content from the server 34 via computer network 50. The network 50 may take the form of a local area network (LAN), wide area network (WAN), wired network, wireless network, personal area network, or a combination thereof, and may include the Internet. Computing device 26 may also receive content directly from broadcast television provider 42 via a suitable digital broadcast signal such as, for example, a signal complying with Advanced Television Systems Committee (ATSC) standards, Digital Video Broadcast-Terrestrial (DVB-T) standards, etc. In other examples, content from broadcast television provider 42 may also be received via network 50.

FIG. 1 also shows an aspect of the computing device 26 in the form of removable computer-readable storage media 30, shown here in the form of a DVD. The removable computer-readable storage media 30 may be used to store and/or transfer data, including but not limited to the interactive video program 32, metadata, other media content and/or instructions executable to implement the methods and processes described herein. The removable computer-readable storage media 30 may also take the form of CDs, HD-DVDs, Blu-Ray Discs, EEPROMs, and/or floppy disks, among others. Additional details on the computing aspects of the computing device 26 are described in more detail below.

The computing system 14 may also include one or more user input devices 54 that may receive and/or sense user inputs from the user 18. As explained in more detail below, a user input device 54 may enable computing device 26 to provide an interactive video viewing experience to the user 18 through the interactive video program 32. Examples of user input devices include, but are not limited to, depth sensors 58 and/or other image sensors, microphones 62, game controllers 66, touch-based devices, and any other suitable user input device 54 that may provide user input to the computing device 26.

In some embodiments the user input device 54 may comprise a depth sensor 58 that is either separate from the computing device as shown in FIG. 1 or integrated into the computing device 26. The depth sensor 58 may be used to observe objects in the media delivery and presentation environment 10, such as user 18, by capturing image data and distance, or depth, data. Examples of depth sensors 58 may include, but are not limited to, time-of-flight cameras, structured light cameras, and stereo camera systems.

Data from the depth sensor 58 may be used to recognize an actual user input provided by the user 18. In some embodiments, the actual user input may comprise a gesture performed by the user. For example, the gesture may comprise a throwing motion that simulates throwing an imaginary ball toward the display device 22. It will be appreciated that data from the depth sensor 58 may be used to recognize many other gestures, motions or other movements made by the user 18 including, but not limited to, one or more limb motions, jumping motions, clapping motions, head or neck motions, finger and/or hand motions, etc.

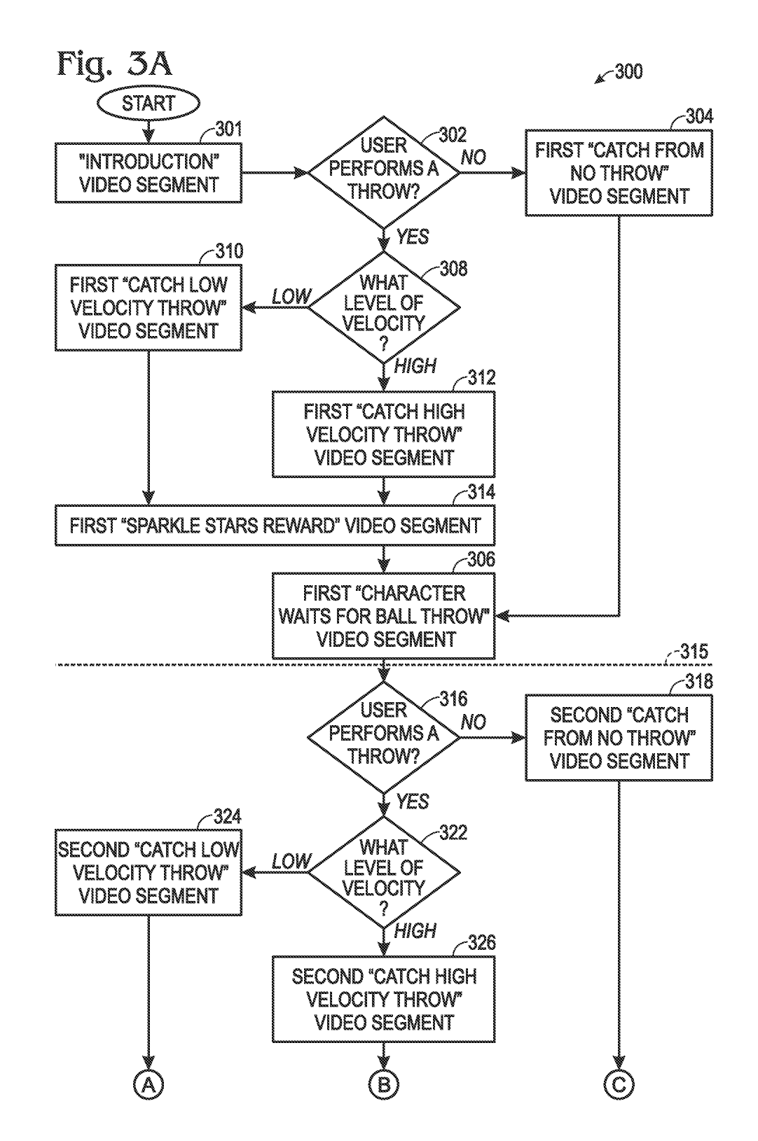

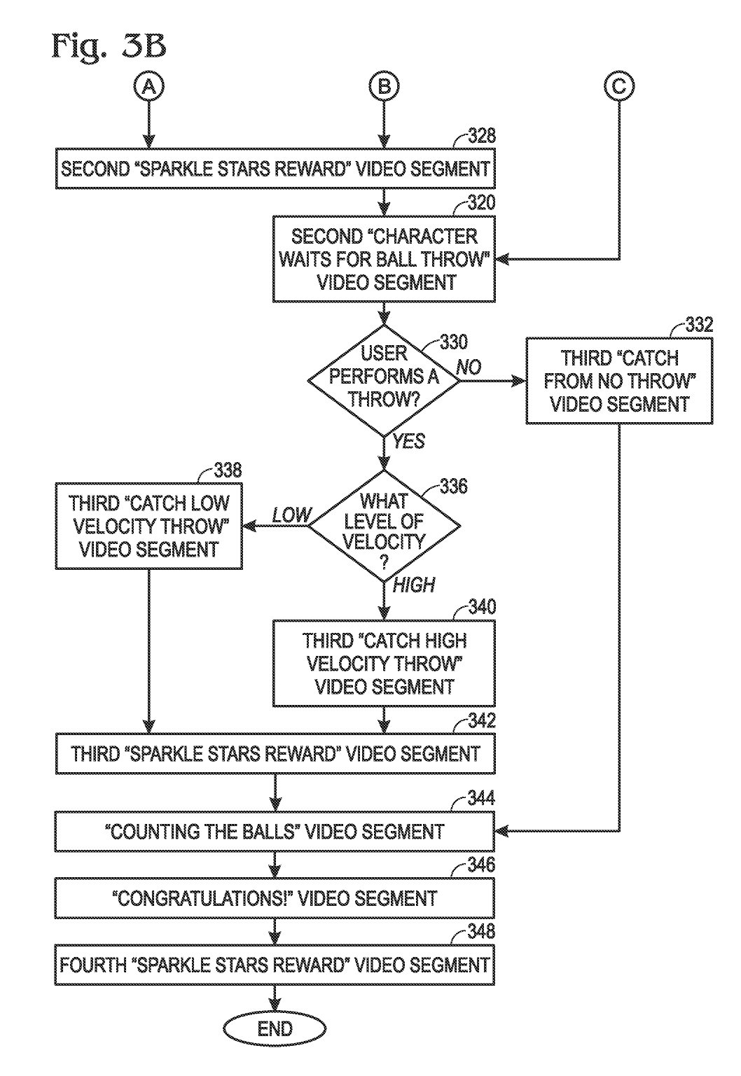

With reference now to FIG. 2, an embodiment of a method 200 of providing an interactive video viewing experience is provided. The method 200 may be performed using the hardware and software components of the computing system 14 described above and shown in FIG. 1, or using any other suitable components. Additionally, FIGS. 3A and 3B illustrate an embodiment of a decision path 300 as a more detailed example of a method of providing an interactive video viewing experience. As described in more detail below, the decision path 300 includes multiple branches leading to one or more branch video segments along the decision path. For convenience of description, the method 200 will be described herein with reference to the components of computing system 14 and the decision path 300 shown in FIGS. 3A and 3B.

As described in more detail below, in some examples the decision path 300 may relate to an interactive video program 32 in which a user 18 is invited to provide a target input in the form of a target gesture. In a more specific example, the target gesture may comprise throwing an imaginary ball to a character displayed on the display 22. In another example, the target gesture may comprise the user jumping in place. It will be appreciated that the target gesture may comprise any gesture, motion or other movement made by the user 18 that may be captured by one or more of the user input devices 54 including, but not limited to, one or more limb motions, jumping motions, clapping motions, head or neck motions, etc.

In a more specific example, the user 18 may be asked to practice the target gesture, and data from the user input device 54 may be used to determine whether the user performs the target gesture. If the user 18 does not perform the target gesture, an additional tutorial video explaining and/or demonstrating the target gesture may be provided to the display device 22.

In some examples, the interactive video program 32 may also include a learning element designed to help users 18 learn numbers and/or letters of an alphabet. In one example, and as described in more detail below with reference to FIGS. 3A and 3B, a Number of the Day may be presented to the user 18. The interactive video program 32 counts each time the user 18 responds to a request from the character on the display 22 by throwing an imaginary ball toward the display. With each throw, the character may congratulate the user 18, and the current number of throws may appear on the display 22. When the number of user throws equals the Number of the Day, the character may give the user 18 additional congratulations and the Number of the Day may be displayed with visual highlights on the display 22.

Turning now to FIG. 2, at 202 the method 200 includes receiving an interactive video program 32 that comprises a first video segment and one or more branch video segments, with each branch video segment corresponding to a branch along a decision path of the interactive video program. As noted above, the interactive video program 32 may be received from DVD 30, broadcast television provider 42, server 34, or any other suitable content provider. Examples of decision path branches and corresponding branch video segments along decision path 300 are provided in more detail below with respect to FIGS. 3A and 3B.

With reference to 301 in FIG. 3A, a first branch video segment may comprise an introduction to the interactive video program that explains the Number of the Day and the target gesture to the user 18. In one example, the Number of the Day may be 3 and the target gesture may comprise throwing the imaginary ball to the character on the display 22 as described above. The introduction may include a portion in which the character asks the user 18 to throw the imaginary ball to the character. With reference to 206 in FIG. 2, the method 200 includes sending the first video segment 301 to the display device 22 for presentation to the user 18.

At 210 in FIG. 2, the method 200 includes pre-buffering a transition portion of a corresponding branch video segment for each possible user input of a set of one or more possible user inputs along the decision path 300. In one example, by pre-buffering a transition portion of one or more branch video segments along the decision path 300, the method 200 may enable interruption-free transitions between video segments. In this manner, user 18 may experience the interactive video program 32 as a continuous video viewing experience that is akin to viewing standard broadcast television, video or motion picture film—except that the user interacts in a real-time manner with one or more characters or other elements in the program.

A transition portion of a branch video segment may comprise a portion of the video segment that, when pre-buffered, enables an interruption-free transition between the currently-displayed video segment and the branch video segment. In some examples, the transition portion of a branch video segment may comprise 1500 milliseconds of video, or any suitable amount of the video segment. In other examples, the size of a transition portion of a branch video may be determined based upon a number of the possible user inputs along the decision path 300.

As explained in more detail below, the decision path 300 may include multiple branches at which user input may be received. At one or more of these branches, the user 18 may be asked to perform a target gesture, in this example a throwing motion. The user 18 may respond to the request in multiple ways—by performing the target gesture, by performing a different gesture, motion, or movement that is not the target gesture, by performing no action (inaction), etc. At each branch where possible user input may be received, the interactive video program 32 may branch to a transition portion of a branch video segment that corresponds to the actual user input that is received. If the actual user input matches a target input at a branch where possible user input may be received, then the interactive video program 32 may branch to a transition portion of a target input branch video segment that corresponds to the target input.

In one example, the method 200 may pre-buffer a transition portion of only those branch video segments corresponding to possible user inputs that occur within a predetermined node depth of the decision path 300. In this manner, the method 200 may conserve resources in the computing device 26 by pre-buffering only a minimum number of branch video segments to allow for interruption-free transitions. In one example and with reference to FIG. 3A, where a current position along decision path 300 is at branch 302, the node depth may include branch video segments 304, 310, 312, 314 and 306 that are each positioned above node depth line 315. Alternatively expressed, the node depth may be set to include the 5 branch video segments that are immediately downstream from branch 302 (e.g., branch video segments 304, 310, 312, 314 and 306). It will be appreciated that other node depths containing more or less branch video segments may be provided. In some examples, the branch video segments that are pre-buffered may be continuously updated to include additional branch video segments as a current position of the decision path 300 moves to a new branch.

Turning to FIG. 3A and as noted above, based upon an actual user input that corresponds to a selected possible input from the set of one or more possible user inputs, the decision path 300 may branch from a current video segment to a transition portion of a branch video segment that corresponds to the actual user input. More specifically, at branch 302 of the decision path 300, the decision path includes determining whether the user 18 performs a throw as requested by a requesting character presented on the display device 22. If the user 18 does not perform a throw, and instead performs another gesture or movement that is not a throwing motion, or performs no gesture or movement, then at 304 the decision path 300 branches to a first “Catch From No Throw” video segment. In one example, the first “Catch From No Throw” video segment may comprise displaying another character on the display device 22 who says to the requesting character, “I'll play with you,” and throws a ball to the requesting character. The requesting character may catch the ball and exclaim, “Catch number 1!” and the number 1 may be displayed on the display device 22.

At 306 the decision path 300 may then branch to a transition portion of a first “Character Waits For Ball Throw” video segment. In one example the “Character Waits For Ball Throw” video segment may comprise the requesting character holding a basket out as if to catch a ball while saying, “Throw me the ball and I'll catch it in my favorite basket!”

Returning to 302, if the user 18 performs a throwing motion then the decision path branches to 308 and determines what level of velocity to assign to the user's throwing motion. In one example, data from the depth sensor 58 may be used to determine a velocity of the user's arm during the throwing motion. If the velocity is less than or equal to a threshold velocity, then the decision path may characterize the velocity as “low velocity.” If the velocity is greater than the threshold velocity, then it may be characterized as “high velocity.”

It will be appreciated that other gesture variations, aspects, characteristics and/or qualities of the user's movement or other user action may be used to assign a relative status to the user action. Such variations, aspects, characteristics and/or qualities of the user's gesture, movement or other user action may include, but are not limited to, a type of gesture (for example, an overhand, sidearm, or underhand throwing motion), a magnitude of a movement or action (for example, a height of a jumping motion or a decibel level of a user's vocal response), a response time of a user's response to a request, etc. Based on a relative status, or gesture variation, assigned to the user's actual gesture, the interactive video program may branch to a gesture variation branch video segment that corresponds to the gesture variation assigned to the user's actual gesture.

Returning to 308, and based on the level of velocity of the user's throwing motion, the decision path may branch to a transition portion of either branch video segment 310 or branch video segment 312. If the user's throwing motion is determined to be a low velocity throw, then at 310 the decision path 300 branches to a transition portion of a first “Catch Low Velocity Throw” video segment. In one example, the first “Catch Low Velocity Throw” video segment may comprise the requesting character holding out a basket, a ball flying into the scene, and the character catching the ball in the basket. The character may then say, “I caught the ball! Catch number 1!” and a number 1 may be displayed on the display device. At 314 the decision path may then branch to a transition portion of a first “Sparkle Stars Reward” video segment that adds sparkles around the number 1 displayed on the display device. From 314 the decision path may branch to 306 and the first “Character Waits For Ball Throw” video segment.

Returning to 308, if the user's throwing motion is determined to be a high velocity throw, then at 312 the decision path 300 branches to a transition portion of a first “Catch High Velocity Throw” video segment. In one example, the first “Catch High Velocity Throw” video segment may comprise the requesting character holding out a basket, a ball flying into the scene, and the character catching the ball in the basket. The character may then say, “Did you see me catch the ball?! Catch number 1!” and a number 1 may be displayed on the display device. At 314 the decision path may then branch to a transition portion of the first “Sparkle Stars Reward” video segment that adds sparkles around the number 1 displayed on the display device. From 314 the decision path may branch to 306 and the first “Character Waits For Ball Throw” video segment.

At 306 the decision path may branch to 316 to determine whether the user 18 performs another throw as requested by the requesting character. If the user 18 does not perform a throw, then at 318 the decision path 300 branches to a second “Catch From No Throw” video segment. In one example, the second “Catch From No Throw” video segment may comprise displaying another character on the display device 22 who tells the requesting character, “Here's another one,” and throws a ball to the requesting character. The requesting character may catch the ball and exclaim, “Easy one! Catch number 2!” and the number 2 may be displayed on the display device 22. With reference now to FIG. 3B, the decision path 300 may then branch to a transition portion of a second “Character Waits For Ball Throw” video segment 320. In one example, the second “Character Waits For Ball Throw” video segment may comprise the requesting character holding a basket out as if to catch a ball while saying, “I'm ready for another one! Throw again!”

Returning to 316, if the user 18 performs a throwing motion then the decision path 300 branches to 322 and determines what level of velocity to assign to the user's throwing motion. Based on the level of velocity of the user's throwing motion, the decision path may branch to a transition portion of either branch video segment 324 or branch video segment 326.

If the user's throwing motion is determined to be a low velocity throw, then at 324 the decision path 300 branches to a transition portion of a second “Catch Low Velocity Throw” video segment. In one example, the second “Catch Low Velocity Throw” video segment may comprise the requesting character holding out a basket, a ball flying into the scene, and the character catching the ball in the basket. The character may then say, “That was an easy one! Catch number 2!” and a number 2 may be displayed on the display device 22. With reference to FIG. 3B, the decision path 300 may then branch to a transition portion of a second “Sparkle Stars Reward” video segment 328 that adds sparkles around the number 2 displayed on the display device 22. From 328 the decision path may branch to 320 and the second “Character Waits For Ball Throw” video segment.

Returning to 322, if the user's throwing motion is determined to be a high velocity throw, then at 326 the decision path 300 branches to a transition portion of a second “Catch High Velocity Throw” video segment. In one example, the second “Catch High Velocity Throw” video segment may comprise the requesting character holding out a basket, a ball flying into the scene, and the character catching the ball in the basket. The character may then say, “That was a super hard throw! Catch number 2!” and a number 2 may be displayed on the display device 22. With reference to FIG. 3B, at 328 the decision path may then branch to a transition portion of the second “Sparkle Stars Reward” video segment that adds sparkles around the number 2 displayed on the display device 22. From 328 the decision path may branch to 320 and the second “Character Waits For Ball Throw” video segment.

At 320 the decision path 300 may branch to 330 to determine whether the user 18 performs another throw as requested by the requesting character. If the user 18 does not perform a throw, then at 332 the decision path 300 branches to a third “Catch From No Throw” video segment. In one example, the third “Catch From No Throw” video segment may comprise displaying another character on the display device 22 who tells the requesting character, “Here you go,” and throws a ball to the requesting character. The requesting character may catch the ball and exclaim, “I'm the best! Catch number 3 !” and the number 3 may be displayed on the display device 22.

The decision path 300 may then branch to a transition portion of a “Counting The Balls” video segment in which the requesting character may hold the basket out to show the user 18 that there are 3 balls in the basket. The requesting character may say, “Let's see how many balls I caught!” The character may point to a first ball and say, “One!”, then to a second ball and say, “Two!”, and to the third ball and say “Three!” After the character says each number, the corresponding numeral may be displayed with sparkles on the display device 22.

The decision path 300 may then branch to a transition portion of a “Congratulations” video segment that may include the requesting character and/or the other character congratulating the user 18 and telling the user, “Three! That's brilliant! Great job!” The decision path 300 may then branch to a transition portion of a fourth “Sparkle Stars Reward” video segment 348 that presents a sparkling fireworks display to the user 18 on the display device 22. The decision path 300 may then end.

Returning to 330, if the user 18 performs a throwing motion then the decision path branches to 336 and determines what level of velocity to assign to the user's throwing motion. Based on the level of velocity of the user's throwing motion, the decision path may branch to a transition portion of either branch video segment 338 or branch video segment 340.

If the user's throwing motion is determined to be a low velocity throw, then at 338 the decision path 300 branches to a transition portion of a third “Catch Low Velocity Throw” video segment. In one example, the third “Catch Low Velocity Throw” video segment may comprise the requesting character holding out a basket, a ball flying into the scene, and the character catching the ball in the basket. The character may then say, “I wonder if I can eat these! Catch number 3!” and a number 3 may be displayed on the display device 22. The decision path 300 may then branch to a transition portion of a third “Sparkle Stars Reward” video segment 342 that adds sparkles around the number 3 displayed on the display device 22. From 342 the decision path may branch to 344 and the “Counting the Balls” video segment, followed by the “Congratulations” video segment at 346 and the fourth “Sparkle Stars Reward” video segment at 348. The decision path 300 may then end.

Returning to 336, if the user's throwing motion is determined to be a high velocity throw, then at 340 the decision path 300 branches to a transition portion of a third “Catch High Velocity Throw” video segment. In one example, the third “Catch High Velocity Throw” video segment may comprise the requesting character holding out a basket, a ball flying into the scene, and the character catching the ball in the basket. The character may then say, “I'm the ball catching king of the world! Catch number 3!” and a number 3 may be displayed on the display device 22. The decision path may then branch to a transition portion of the third “Sparkle Stars Reward” video segment at 342 that adds sparkles around the number 3 displayed on the display device 22. From 342 the decision path may branch to 344 and a transition portion of the “Counting the Balls” video segment, followed by the “Congratulations” video segment at 346 and the fourth “Sparkle Stars Reward” video segment at 348, thereby concluding the decision path.

In this manner, the interactive video presentation may play without pausing to wait for user inputs at decision points, and may play in full even if the user action at each decision point is inaction. This is in contrast to conventional video games that incorporate video segments, which may wait at a decision point to receive input before continuing play.

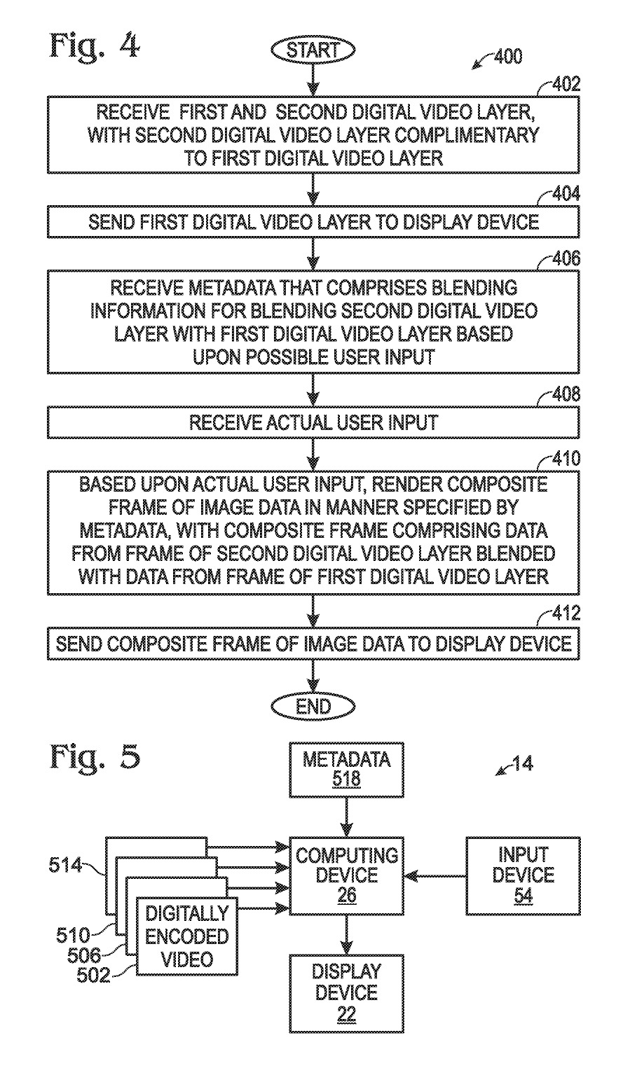

With reference now to FIG. 4, another example embodiment of a method 400 of providing an interactive video viewing experience is provided. The method 400 may be performed using the hardware and software components of the computing system 14 or any other suitable components. For convenience of description, a simplified schematic illustration of selected components of computing system 14 is illustrated in FIG. 5. The method 400 will be described herein with reference to the components of computing system 14 shown in FIG. 5.

With reference now to FIG. 4, at 402 the method 400 may comprise receiving a first digital video layer and a second digital video layer, with the second digital video layer being complimentary to the first digital video layer. As illustrated in FIG. 5, the computing device 26 may receive multiple digitally encoded files or data structures containing multiple layers of video. In other examples, the computing device 26 may receive multiple layers of digitally encoded video as a single encoded file or data structure. In these examples, the computing device 26 may parse the file or data structure into multiple layers of digitally encoded video. The computing device 26 then decodes the multiple layers of digitally encoded video and blends two or more layers as described in more detail below.

As noted above with reference to FIG. 1, the digitally encoded video may be received from DVD 30, broadcast television provider 42, server 34, or any other suitable content source. In some examples, the digitally encoded video may comprise produced, pre-recorded linear video. In other examples, the digitally encoded video may comprise one or more streams of live, broadcast television. The digitally encoded video may also be received in any suitable video compression format, including, but not limited to, WINDOWS MEDIA Video format (.wmv), H.264/MPEG-4 AVC (Advanced Video Coding), or other suitable format or standard.

As shown in FIG. 5, in one example the computing device 26 may receive a first digital video layer 502, a second digital video layer 506, a third digital video layer 510, and a fourth digital video layer 514. It will be appreciated that more or less digital video layers may also be received by the computing device 26. In one example, the second digital video layer 506 may be complimentary to the first digital video layer 502. For purposes of the present disclosure, and as described in more detail below, a second digital video layer may be complimentary to a first digital video layer when the second layer changes, enhances, or otherwise alters the user's perception of the first layer. Additionally and as described in more detail below, metadata 518 received by the computing device 26 may describe, implement, or otherwise relate to one or more complimentary aspects of the second digital video layer with respect to the first digital video layer. Metadata 518 may be synchronized with the first digital video layer 502 and the second digital video layer 506, and may be used to specify a manner of rendering a composite frame of image data based on an actual user input specified by the metadata. Metadata 518 may be received from the server 34, broadcast television provider 42, DVD 30, or other suitable content source. Additionally, metadata 518 may be contained in an XML data file or any other suitable data file.

In one example, the second digital video layer 506 may be complimentary to the first digital video layer 502 by virtue of an element in the second digital video layer that comprises a visual effect applied to an element in the first digital video layer. In a more specific example, the first digital video layer 502 may comprise a scene depicting a cow jumping over the moon in a night sky. The moon may be shown as it commonly appears with various craters and shadows, for example. The second digital video layer 506 may comprise a modified moon that appears identical to the moon in the first digital video layer 502, except that the modified moon includes two eyes that are synchronized to follow the cow's movement over the moon from one side to the other.

At 404 the method comprises sending the first digital video layer 502 of the scene depicting a cow jumping over the moon to the display device 22. At 406, the method comprises receiving metadata 518 that comprises blending information for blending the second digital video layer 506 (in this example, the modified moon) with the first digital video layer 502 (in this example, the moon without the two eyes) based upon a possible user input. At 508, the method comprises receiving an actual user input. In one example, the actual user input may comprise the user pointing at the moon that is shown in the first digital video layer 502. The computing device 26 may receive this actual user input in the form of data from the depth sensor 58 that corresponds to the user's movements.

Based upon the actual user input, and where the actual user input (in this example, pointing at the moon) matches the possible user input (in this example, pointing at the moon), at 410 the method 400 renders a composite frame of image data in a manner specified by the metadata 518. The composite frame of image data may comprise data from a frame of the second digital video layer 506 that is blended with data from a frame of the first digital video layer 502. At 412, the method 400 sends the composite frame of image data to the display device 22.

In the present example, the composite frame of image data blends the modified moon containing the two eyes with the moon shown in the first digital video layer 502. As experienced by the user 18, when the user points at the moon two eyes appear on the moon and follow the cow's movement over the moon. Additionally, because the second digital video layer 506 is synchronized with the first digital video layer 502, when the eyes are revealed upon the user pointing at the moon, the eyes are looking at the cow and continue to follow the cow over the moon.

It will be appreciated that many other and various visual effects may be provided by one or more elements in a digital video layer. Other visual effects include, but are not limited to, zooming into a portion of a scene, creating a “lens” that may move around the scene to magnify different areas of the scene, launching another digital video layer, revealing another digital video layer that is running in parallel, etc. One or more visual effects may also be triggered and/or controlled by actual user input from the user 18.

In other examples, the second digital video layer 506 may comprise one or more links to additional content. In a more specific example, the second digital video layer 506 may include a link that the user 18 may select by performing a gesture or motion related to the link. The user 18 may point at the link to select it, may manipulate an element on the display device 22 to select it, etc. Once selected, the link may expose hidden layers of content on the display device, such as clues for a game, more detailed information regarding an educational topic, or other suitable content.

In some examples, rendering the composite frame of image data may occur at a location remote from the computing device 26, such as at server 34. The composite frame of image data may be received by the computing device 26 from the server 34, and then sent to the display device 22. In other examples, rendering the composite frame of image data may occur on the computing device 26 at runtime.

In another example, the metadata 518 may comprise blending information that instructs the computing device 26 to select a second digital video layer based upon a timing of a user action. In the present example, if the user points at the moon within a predetermined time period, such as while the cow is jumping over the moon, then the computing device 26 may proceed to blend the second digital video layer 506 with the first digital video layer 502 as described above. If the user does not point at the moon within the predetermined time period, then the computing device may continue sending the first digital video layer 502 to the display device 22. In other examples, the metadata 518 may comprise blending information that instructs the computing device 26 to select a second digital video layer based upon one or more variations of the user action.

In other examples, the third digital video layer 510 and/or fourth digital video layer 514 may be complimentary to the first digital video layer 502. In these examples, the metadata 518 may comprise blending information for blending the third digital video layer 510 and/or fourth digital video layer 514 with the first digital video layer 502 based upon actual input from the user. In this manner, the composite frame of image data may comprise data from a frame of the third digital video layer 510 and/or fourth digital video layer 514 that is blended with data from a frame of the first digital video layer 502.

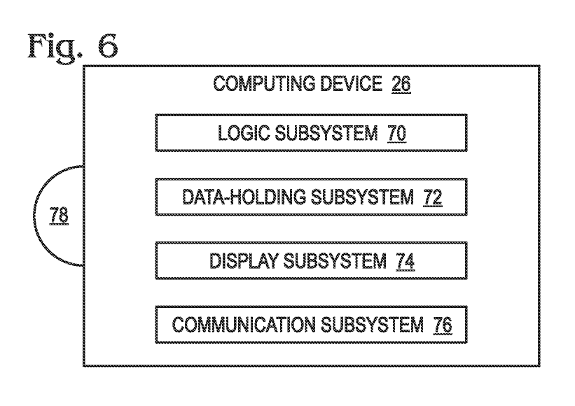

FIG. 6 schematically illustrates a nonlimiting embodiment of computing device 26 that may perform one or more of the above described methods and processes. Computing device 26 is shown in simplified form. It is to be understood that virtually any computer architecture may be used without departing from the scope of this disclosure. In different embodiments, computing device 26 may take the form of a set-top box (e.g. cable television box, satellite television box), digital video recorder (DVR), desktop computer, laptop computer, tablet computer, home entertainment computer, network computing device, etc. Further, in some embodiments the methods and processes described herein may be implemented as a computer application, computer service, computer API, computer library, and/or other computer program product in a computing system that includes one or more computers.

As shown in FIG. 6, computing device 26 includes a logic subsystem 70, a data-holding subsystem 72, a display subsystem 74, and a communication subsystem 76. Computing device 26 may also optionally include a sensor subsystem and/or other subsystems and components not shown in FIG. 6.

Logic subsystem 70 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 70 may include one or more processors that are configured to execute software instructions. Additionally or alternatively, the logic subsystem 70 may include one or more hardware or firmware logic machines configured to execute hardware or firmware instructions. Processors of the logic subsystem 70 may be single core or multicore, and the programs executed thereon may be configured for parallel or distributed processing.

Data-holding subsystem 72 may include one or more physical, non-transitory devices configured to hold data and/or instructions executable by the logic subsystem to implement the methods and processes described herein. When such methods and processes are implemented, the state of data-holding subsystem 72 may be transformed (e.g., to hold different data). As noted above with reference to FIG. 1, data-holding subsystem may include one or more interactive video programs 32.

Data-holding subsystem 72 may include removable media and/or built-in devices. Data-holding subsystem 72 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 72 may include devices with one or more of the following characteristics: volatile, nonvolatile, dynamic, static, read/write, read-only, random access, sequential access, location addressable, file addressable, and content addressable. In some embodiments, logic subsystem 70 and data-holding subsystem 72 may be integrated into one or more common devices, such as an application specific integrated circuit or a system on a chip.

FIG. 6 also shows an aspect of the data-holding subsystem 72 in the form of removable computer-readable storage media 78, which may be used to store and/or transfer data and/or instructions executable to implement the methods and processes described herein. Removable computer-readable storage media 78 may take the form of the DVD 30 illustrated in FIG. 1, CDs, HD-DVDs, Blu-Ray Discs, EEPROMs, and/or floppy disks, among others.

It is to be appreciated that data-holding subsystem 72 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

As described above, display subsystem 74 includes one or more image display systems, such as display device 22, configured to present a visual representation of data held by data-holding subsystem 72. As the methods and processes described herein change the data held by the data-holding subsystem 72, and thus transform the state of the data-holding subsystem, the state of display subsystem 74 may likewise be transformed to visually represent changes in the underlying data.

Communication subsystem 76 may be configured to communicatively couple computing device 26 with network 50 and/or one or more other computing devices. Communication subsystem 76 may include wired and/or wireless communication devices compatible with one or more different communication protocols. As nonlimiting examples, communication subsystem 76 may be configured for communication via a wireless telephone network, a wireless local area network, a wired local area network, a wireless wide area network, a wired wide area network, etc. In some embodiments, communication subsystem 76 may allow computing device 26 to send and/or receive messages to and/or from other devices via a network such as the Internet.

The term “program” may be used to describe an aspect of the computing system 14 that is implemented to perform one or more particular functions. In some cases, such a program may be instantiated via logic subsystem 70 executing instructions held by data-holding subsystem 72. It is to be understood that different programs may be instantiated from the same application, service, code block, object, library, routine, API, function, etc Likewise, the same program may be instantiated by different applications, services, code blocks, objects, routines, APIs, functions, etc. The term “program” is meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing device, a method of providing an interactive video viewing experience, the method comprising:
receiving an interactive video program comprising a first video segment, and also comprising one or more branch video segments that each corresponds to a branch along a decision path of the interactive video program;
for each possible user input of a set of one or more possible user inputs along the decision path, pre-buffering a transition portion of a corresponding branch video segment;
sending the first video segment to a display device; and
based upon an actual user input received that corresponds to a selected possible input from the set of one or more possible user inputs, branching from the first video segment to a transition portion of a branch video segment that corresponds to the actual user input.

2. The method of claim 1, wherein each of the corresponding branch video segments that includes a pre-buffered transition portion occurs within a node depth of the decision path.

3. The method of claim 1, further comprising determining a size of the transition portion of each of the corresponding branch video segments based upon a number of the possible user inputs along the decision path.

4. The method of claim 1, wherein the actual user input comprises inaction.

5. The method of claim 1, further comprising:
if the actual user input matches a target input, then branching from the first video segment to a transition portion of a first target input branch video segment; and
if the actual user input does not match the target input, then branching from the first video segment to a transition portion of a second target input branch video segment.

6. The method of claim 1, wherein the actual user action comprises a gesture performed by the user.

7. The method of claim 6, wherein if the gesture comprises a first gesture variation, then the method further comprising branching from the first video segment to a transition portion of a first gesture variation branch video segment; and
if the gesture comprises a second gesture variation, then the method further comprising branching from the first video segment to a transition portion of a second gesture variation branch video segment.

8. The method of claim 1, further comprising receiving input from a user input device that senses the actual user input.

9. The method of claim 8, wherein the user input device comprises a depth sensor.

10. In a computing device, a method of providing an interactive video viewing experience, the method comprising:
receiving a first digital video layer and a second digital video layer, the second digital video layer being complimentary to the first digital video layer;
receiving metadata that comprises blending information for blending the second digital video layer with the first digital video layer based upon a possible user input;
sending the first digital video layer to a display device;
receiving an actual user input;
based upon the actual user input, rendering a composite frame of image data in a manner specified by the metadata, the composite frame of image data comprising data from a frame of the second digital video layer that is blended with data from a frame of the first digital video layer; and
sending the composite frame of image data to the display device.

11. The method of claim 10, further comprising synchronizing the first digital video layer, the second digital video layer and the metadata.

12. The method of claim 10, wherein first digital video layer comprises pre-recorded linear video.

13. The method of claim 10, further comprising:
receiving one or more additional digital video layers, each of the additional digital video layers being complimentary to the first digital video layer;
receiving metadata that comprises blending information for blending a selected additional digital video layer from the one or more additional digital video layers with the first digital video layer based upon the actual user input; and
wherein the composite frame of image data comprises data from a frame of the selected additional digital video layer that is blended with data from a frame of the first digital video layer.

14. The method of claim 10, wherein the second digital video layer comprises one or more of first additional content and a link to second additional content.

15. The method of claim 10, wherein an element in the second digital video layer comprises a visual effect applied to an element in the first digital video layer.

16. The method of claim 10, wherein the blending information of the metadata comprises one or more of information related to a user position, information related to a blending effect, information related to a timing of a user action, and information related to variations of the user action.

17. The method of claim 10, wherein the actual user input comprises user inaction.

18. A computer readable storage medium comprising instructions stored thereon and executable by a computing device to provide an interactive video viewing experience, the instructions being executable to:
receive a first digital video layer;
receive a second digital video layer that is complimentary to the first digital video layer;
receive metadata defining how to render a composite frame of image data based upon a user input received at a user input device, the composite frame of image data comprising data from a frame of the second digital video layer that is blended with data from a frame of the first digital video layer;
render the composite frame of image data; and
provide the composite frame of image data to a display device.

19. The computer readable storage medium of claim 18, wherein the instructions are executable by the computing device to synchronize the first digital video layer, the second digital video layer and the metadata.

20. The computer readable storage medium of claim 18, wherein the instructions are executable by the computing device to:
receive one or more additional digital video layers, each of the additional digital video layers being complimentary to the first digital video layer;
receive metadata that comprises blending information for blending a selected additional digital video layer from the one or more additional digital video layers with the first digital video layer based upon the actual user input; and
wherein the composite frame of image data comprises data from a frame of the selected additional digital video layer that is blended with data from a frame of the first digital video layer.
